(19) United States
(12) Patent Application Publication
(10) Pub. No.: US 2026/0221760 A1
(43) Pub. Date: Jul. 30, 2026

(54) CENTRALIZED PROTECTION SCHEME FOR DC POWER DISTRIBUTION SYSTEM

(71) Applicant: EATON INTELLIGENT POWER LIMITED, DUBLIN (IE)

(72) Inventors: Haosen Guo, Oakland Township, MI (US); Dmitry Ishchenko, Cary, NC (US); Edward Buck, Waldo, WI (US); Steven Z. Chen, Coraopolis, PA (US); Steven Schmalz, Franklin, WI (US); Qianqian Jiao, Canonsburg, PA (US)

(73) Assignee: EATON INTELLIGENT POWER LIMITED, DUBLIN (IE)

(21) Appl. No.: 19/345,143

(22) Filed: Sep. 30, 2025

Related U.S. Application Data
(60) Provisional application No. 63/751,419, filed on Jan. 30, 2025.

(51) Int. Cl. H02H 7/26; H02H 3/033; H02H 3/06; H02H 3/087; H02H 3/10; H02H 3/32

(52) U.S. Cl. CPC H02H 7/263; H02H 3/033; H02H 3/06; H02H 3/087; H02H 3/10; H02H 3/32; H02H 7/268

(57) ABSTRACT

A centralized protection scheme manages faults in a DC power distribution system through a centralized controller that monitors all direct current circuit breakers (DCCBs), each linked to a specific zone. When fault data is detected, the controller compares it to a fault characteristic database to identify the fault type and location. It then trips only the DCCB(s) in the affected zone(s), isolating faults while maintaining power to unaffected areas. To ensure reliability, backup protection activates if a DCCB fails, allowing adjacent or upstream devices to isolate the fault. After successful interruption, the controller initiates automated reconfiguration, such as rerouting power or activating redundant components, to restore service. This dynamic approach enhances system resilience, minimizes downtime, and ensures critical loads remain operational during fault conditions.

### CROSS REFERENCE TO RELATED APPLICATIONS

This application claims priority to U.S. Patent Application Serial No. 63/751,419, filed January 30, 2025 entitled, “Centralized Protection Scheme For DC Power Distribution System”.

### GOVERNMENT CONTRACT

This invention was made with government support under N00024-23-C-4114 awarded by the U.S. Navy. The government has certain rights in the invention.

### FIELD OF THE INVENTION

The disclosed concept relates generally to power distribution systems, and in particular, to systems and methods for managing faults in DC power distribution systems.

### BACKGROUND OF THE INVENTION

In traditional DC power distribution systems, protection schemes are generally decentralized, relying on local circuit breakers to manage faults. While these systems are effective to an extent, they face significant limitations. In complex, multi-zone DC power distribution systems, known decentralized protection schemes encounter difficulties in coordinating responses across multiple points in the network. In addition, known decentralized protection schemes may not reliably detect fault characteristics, leading to delayed isolation, or may falsely isolate unaffected sections.

The limitations in decentralized schemes result in challenges such as: (1) delayed fault detection and isolation, (2) coordination challenges, (3) and increased downtime and damage risk. Delayed fault detection and isolation occur because localized breakers may not identify fault types or directions efficiently, especially in complex zonal setups, causing delays in system response. Coordination challenges occur because lack of a unified control makes it difficult to coordinate among different zones, leading to possible over-isolation or under-protection. Increased downtime and damage risk occur because, without centralized data processing, faults may propagate, damaging critical loads like radar systems, AC motors, and auxiliary generators before isolation occurs.

There is thus room for improvement in DC power distribution systems and in fault management schemes therefor.

### SUMMARY OF THE INVENTION

These needs, and others, are met by embodiments of a centralized protection scheme that implements a fault management method in which a centralized controller continuously monitors all direct current circuit breakers (DCCBs) in a power distribution system, with each DCCB being associated with a specific zone in the system. When the centralized controller receives data indicative of a fault condition from one of the DCCBs, the centralized controller compares the data to a fault characteristic database in order to identify the specific type and location of the fault. Once the specific type and location of the fault are determined, the centralized controller can selectively trip only the DCCB or DCCBs of the affected zone(s) in order to isolate the faulted zones from the larger system while the cause of the fault is determined and/or cleared, enabling the unaffected zones to continue receiving power without interruption.

In one embodiment of the disclosed concept, a centralized controller for managing faults in a DC power distribution system is provided, the DC power distribution having a positive pole and a negative pole, and including a plurality of interconnected distributed energy systems and a plurality of direct current circuit breakers (DCCBs). The plurality of DCCBs includes a plurality of source branch breakers, a plurality of load branch breakers, and a plurality of tie breakers. Each of the interconnected distributed energy systems is configured to be connected to and disconnected from at least one other of the interconnected distributed energy systems via a number of the tie breakers. Each interconnected distributed energy system includes a plurality of power sources, a plurality of loads, and a DC Bus, with each power source being connected to a number of the source branch breakers in a source branch such that any of the number of the source branch breakers can be tripped in order to interrupt current flowing from the power source to the DC Bus, and with each load being connected to a number of the load branch breakers in a load branch such that any of the number of the load branch breakers can be tripped in order to interrupt current flowing through the DC Bus to the load. Each interconnected distributed energy system is configured to include a number of zones such that, within each zone, each power source is configured to supply power to a subset of the plurality of loads that is unique relative to any other power source in the DC power distribution system. The centralized controller comprises a fault characteristic database. The fault characteristic database including a plurality of sets of characteristics, with each set of characteristics corresponding to a unique combination of a fault type and a location in the DC power distribution system, such that the combination corresponding to any given set of characteristics is unique relative to all other combinations corresponding to all other sets of characteristics in the fault characteristic database. The centralized controller is configured to execute a method for isolating faults in the DC power distribution system, the method comprising: continuously monitoring electrical current data transmitted by all DCCBs in the DC power distribution system with the centralized controller; when the electrical current data includes any flag for a present current irregularity, running an algorithm for fault matching with the centralized controller to compare the electrical current data to the fault characteristic database; performing fault type identification with the centralized controller during the running of the algorithm. Performing fault type identification includes: first determining if the electrical current data matches one specific set of characteristics out of the plurality of sets of characteristics in the fault characteristic database; and when the electrical current data is determined to match the one specific set of characteristics, next determining that the present current irregularity is a fault of the fault type and location that the one specific set of characteristics corresponds to, including determining whether the present current irregularity is of a PP-G fault type, a PP-NP fault type, or a NP-G fault type. When the electrical current data corresponds to the PP-G fault type or to the PP-NP fault type, performing fault type identification further includes isolating the fault by: transmitting a trip signal with the centralized controller to only the DCCB or DCCBs immediately adjacent to the fault; determining with the centralized controller whether the present fault has been cleared within a predetermined acceptable window of time; when the present fault has been cleared within the predetermined acceptable window of time, proceeding to continuously monitor electrical current data transmitted by all DCCBs in the DC power distribution system with the centralized controller; and when the present fault has not yet been cleared within the predetermined acceptable window of time, proceeding to trip a number of the DCCBs that are backup DCCBs, the backup DCCBs being those DCCBs that are next-closest and upstream relative to the present fault. When the electrical current data corresponds to the NP-G fault type, performing fault type identification further includes: notifying a system operator of the present fault and proceeding to continuously monitor electrical current data transmitted by all DCCBs in the DC power distribution system with the centralized controller.

### BRIEF DESCRIPTION OF THE DRAWINGS

A full understanding of the invention can be gained from the following description of the preferred embodiments when read in conjunction with the accompanying drawings in which:

FIG. 1 shows an example implementation of an improved centralized protection scheme for a power distribution system, in accordance with an example embodiment of the disclosed concept;

FIG. 2 is a flow chart of an improved fault management method for execution in a centralized protection scheme for a power distribution system, in accordance with an example embodiment of the disclosed concept;

FIG. 3 is a table showing example reference data stored in a fault characteristic database included in a centralized controller of the centralized protection scheme of FIG. 1, in accordance with an example embodiment of the disclosed concept;

FIG. 4 shows current flow through various subsections of one interconnected distributed energy system of the improved centralized protection scheme of FIG. 1, under normal operating conditions;

FIG. 5 shows current flow through the same interconnected distributed energy system of FIG. 4, during a positive pole to negative pole (PP-NP) fault; and

FIG. 6 is a flow chart of a fault matching algorithm executed by the module included in the centralized controller of the centralized protection scheme of FIG. 1, in accordance with an example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As employed herein, when ordinal terms such as “first” and “second” are used to modify a noun, such use is simply intended to distinguish one item from another, and is not intended to require a sequential order unless specifically stated.

As employed herein, the term “controller” shall mean a programmable analog and/or digital device that can store, retrieve and process data; a processor; a control circuit; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “number” shall mean one or an integer greater than one (i.e., a plurality).

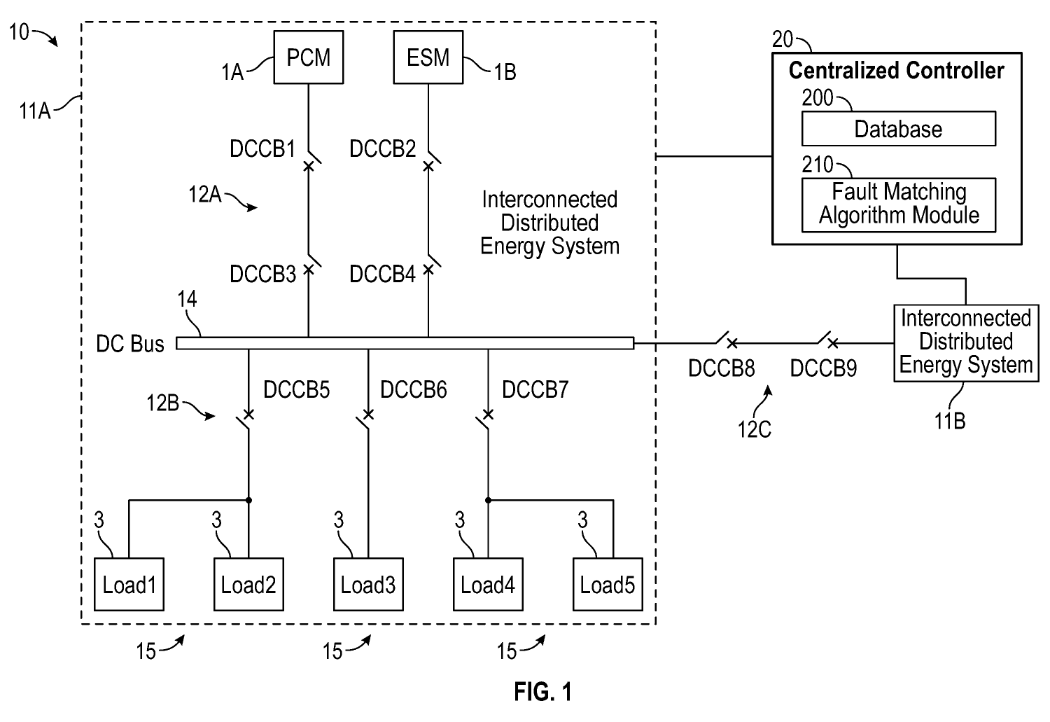

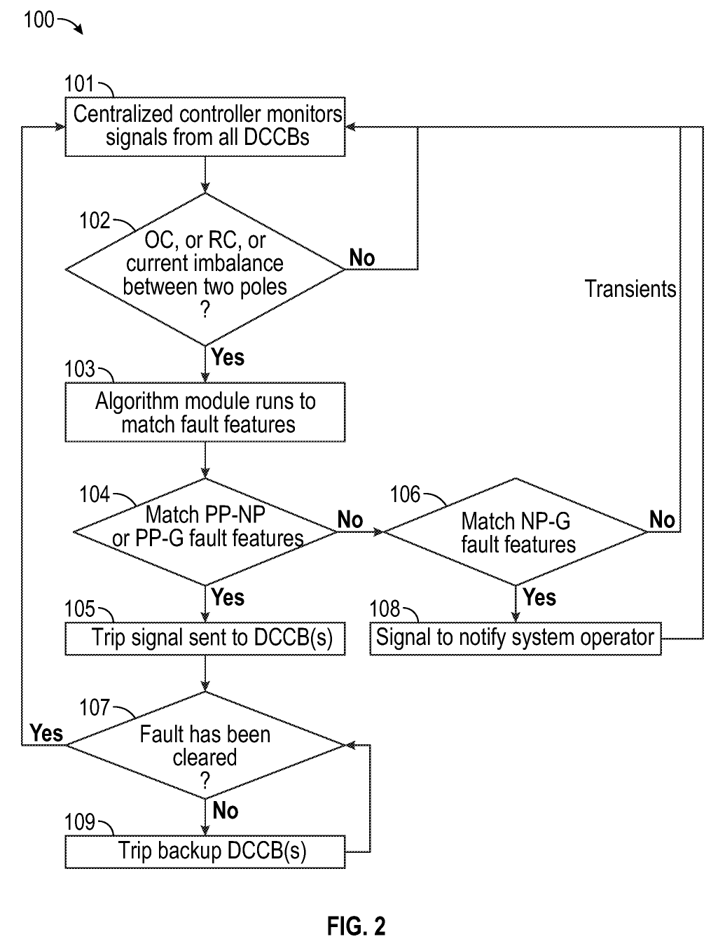

In DC power distribution systems, it is desirable to quickly identify, classify, and isolate faults to avoid extensive downtime and prevent damage to essential systems. Disclosed herein is an innovative centralized power management protection scheme 10 (an example implementation of which is shown in FIG. 1) that executes an innovative fault management method 100 (depicted in the flow chart in FIG. 2) for a DC power distribution system. The centralized power management protection scheme 10 is referred to hereinafter as the “centralized protection scheme 10” for brevity. The centralized protection scheme 10 and fault management method 100 disclosed herein address the shortcomings of known protection schemes for DC power distribution systems by gathering data from multiple points across the network and making coordinated decisions at a centralized controller. The centralized approach of the disclosed centralized protection scheme 10 and method 100 overcomes the limitations of known protection schemes which implement individualized, localized (i.e. decentralized) protection, such limitations including inaccurate fault location and isolation. The disclosed centralized protection scheme 10 continuously monitors real-time current measurements from direct current circuit breakers (DCCBs) across various zones in a DC distribution network.

Referring to FIG. 1, the centralized protection scheme 10 is configured to be implemented in a DC power distribution network comprising a number of interconnected distributed energy systems 11, with each interconnected distributed energy system 11 including a number of power sources 1 configured to electrically power a plurality of loads 3. As an initial note, any time reference is made herein to the “two poles”, it should be understood that the two poles are the positive and negative poles of the DC system. In FIG. 1, several components are numbered with reference numbers that have a letter appended. There are multiple instances of each type of component in the centralized protection scheme 10, and the inclusion of the letter in a reference number enables reference to be made to a specific individual component as necessary to increase clarity when detailing aspects of the centralized protection scheme 10 herein. However, any component numbered with a reference number having a letter appended can also be referred to generally using the reference number without the letter appended. As an illustrative example, in FIG. 1, two interconnected distributed energy systems 11A and 11B are shown, and the interconnected distributed energy systems 11A, 11B can be referred to generally and individually or generally and collectively with the reference number 11.

In FIG. 1, although only the interconnected distributed energy system 11A is shown in detail while the interconnected distributed energy system 11B is shown in simplified form, it should be understood that the interconnected distributed energy system 11B comprises similar components as the interconnected distributed energy system 11A. Each interconnected distributed energy system 11 comprises a plurality of DC circuit breakers 12 (DCCBs) connected to a DC bus 14. For brevity, the DC circuit breakers 12 are referred to hereinafter as the “circuit breakers 12”, but it should be understood that the circuit breakers 12 are all DC circuit breakers. It will be appreciated that the exact number of interconnected distributed energy systems 11 and therefore the exact number of power sources 1, circuit breakers 12, and DC buses 14 included in a given implementation of the centralized protection scheme 10 are context-dependent (i.e. dependent upon the number and type of loads to be powered). As such, it should be understood that the centralized protection scheme 10 can be implemented using different quantities of interconnected distributed energy systems 11, power sources 1, DC buses 14, and circuit breakers 12 than are shown in FIG. 1 without departing from the scope of the disclosed concept. The centralized protection scheme 10 is detailed herein while referencing the interconnected distributed energy system 11A shown in FIG. 1, but it should be understood that description of the interconnected distributed energy system 11A is applicable to any other interconnected distributed energy systems 11 that can be included in the power distribution network.

In FIG. 1, each individual circuit breaker 12 is labeled with “DCCB” with a number appended, i.e. “DCCB[number]”. The individual DCCB[number] labels in FIG. 1 are used so that reference can be made to each specific individual circuit breaker 12 as necessary to increase clarity when detailing aspects of the centralized protection scheme 10 herein. In the interconnected distributed energy system 11, there are source branch breakers 12A, load branch breakers 12B, and tie breakers 12C, each of which is detailed further hereafter.

The term “source branch breaker” is used herein to refer to a circuit breaker 12 that, within the interconnected distributed energy system 11, is connected between a power source 1 and the DC Bus 14, i.e. upstream of the DC Bus 14. In FIG. 1, the four circuit breakers DCCB1, DCCB2, DCCB3, DCCB 4 that are connected upstream of the DC Bus 14 are source branch breakers 12A. The term “load branch breaker” is used herein to refer to a circuit breaker 12 that, within the interconnected distributed energy system 11, is connected between the DC Bus 14 and a load 3, i.e. downstream of the DC Bus 14, such that said circuit breaker 12 must be closed in order for the corresponding downstream load 3 to receive power from a power source 1. In FIG. 1, the three circuit breakers DCCB5-DCCB7 are load branch breakers 12B.

The term “tie breaker” is used herein to refer to a circuit breaker 12 that can connect or disconnect one interconnected distributed energy system 11 to another interconnected distributed energy system 11. In FIG. 1, the two circuit breakers DCCB 8 and DCCB9 are tie breakers 12C. Each tie breaker 12C is considered upstream relative to each of the standalone systems 11 that the tie breaker 12C is connected to. It is noted that it is not often necessary for more than one tie breaker 12C to be connected between two interconnected distributed energy systems 11, but having more than one tie breaker 12C connected between two systems 11 is sometimes considered desirable for redundancy purposes. Each tie breaker 12C can be either normally closed (NC) or normally open (NO), and it will be appreciated that the NC or NO status of a given tie breaker 12C will depend upon what specific loads 3 need to be powered and what specific power sources 1 are available to power said specific loads 3. That is, considerations such as the current draw of each load 3, the criticality of each load 3, and the capacity of the available power sources 1 will determine whether: the default state of the tie breaker(s) 12C connected between two interconnected distributed energy systems 11 should be normally closed (in order for the two systems 11 to be connected by default) or should be normally open (in order for the two systems 11 to be isolated from each other by default).

While the centralized protection scheme 10 can be used in settings other than marine vessels, it is expected that the centralized protection scheme 10 will be especially advantageous in a marine vessel setting. To that end, if the centralized protection scheme 10 is implemented in a marine vessel, the centralized protection scheme would likely have at least two interconnected distributed energy systems 11 that are connected by normally closed tie breakers 12C. One example of a situation in which a tie breaker 12C might be configured to be normally closed is when a first interconnected distributed energy system 11 has at least one load 3 that is considered a critical load. In the event that any of the power sources 1 in said first interconnected distributed energy system 11 fails or needs to be isolated for any reason and the remaining power source(s) 1 in that first interconnected distributed energy system 11 are not sufficient to meet the demands of the loads 3 in that interconnected distributed energy system 11, the closed connection provided by the normally closed tie breaker(s) 12C between the first interconnected distributed energy system 11 and a second interconnected distributed energy system 11 enables power to be provided to the first interconnected distributed energy system 11 by the second interconnected distributed energy system 11, if necessary.

Each source branch breaker 12A monitors power output by its corresponding upstream power source 1, and the source branch breaker 12A for a given power source 1 must be closed in order for the given power source 1 to supply power to any downstream loads 3. It is noted that the interconnected distributed energy system 11A in FIG. 1 includes a power conversion module (PCM) as one power source 1 (numbered as 1A in FIG. 1) and an energy storage module (ESM) as another power source 1 (numbered as 1B in FIG. 1). The PCM is a generator and converter. The PCM and ESM are included in FIG. 1 because PCMs and ESMs are two types of power sources often used in a marine vessel DC power distribution system, although PCMs and ESMs do not need to be included in any interconnected distributed energy system 11 in the power distribution system. For any load 3, all load branch breakers 12B connected between the load 3 and the DC bus 14 must be closed in order for the load 3 to receive power provided by any of the power sources 1. A single load branch breaker 12B can service multiple loads 3. For example, in FIG. 1, the branch breaker 12B labeled DCCB5 is shown supplying power to two parallel loads 3 (labeled Load 1 and Load 2) and the branch breaker 12B labeled DCCB7 is shown supplying power to two parallel loads 3 (labeled Load 4 and Load 5).

The centralized protection scheme 10 can be used in various configurations of DC power distribution systems, including zone-based and radial systems. FIG. 1 depicts a non-limiting illustrative example implementation of the centralized protection scheme 10 in a zone-based DC power distribution system. The term “zone” is used herein to denote a logical subsection of the centralized protection scheme 10 that can be used to isolate a faulted section. As such, it will be appreciated that different zones will exist in the centralized protection scheme 10 at different times depending on what subsections of the centralized protection scheme 10 need to be configured to be isolated from other subsections. The reference number 15 is used in FIG. 1 in order to generally denote the presence of zones in the centralized protection system, but it should be understood that the exact number of zones 15 and composition of each zone 15 in the centralized protection scheme 10 at any given point in time depends on the conditions within the centralized protection scheme 10 at that given point in time. For simplicity of explanation and understanding, in the present disclosure, each interconnected distributed energy system 11 will be treated as its own zone 15 relative to every other interconnected distributed energy system 11 in the centralized protection scheme. However, it should be understood that each individual interconnected distributed energy system 11 can be configured to include multiple zones 15 within the individual interconnected distributed energy system 11, such that each zone 15 within the single interconnected distributed energy system 11 comprises a specific subsection of that single interconnected distributed energy system 11.

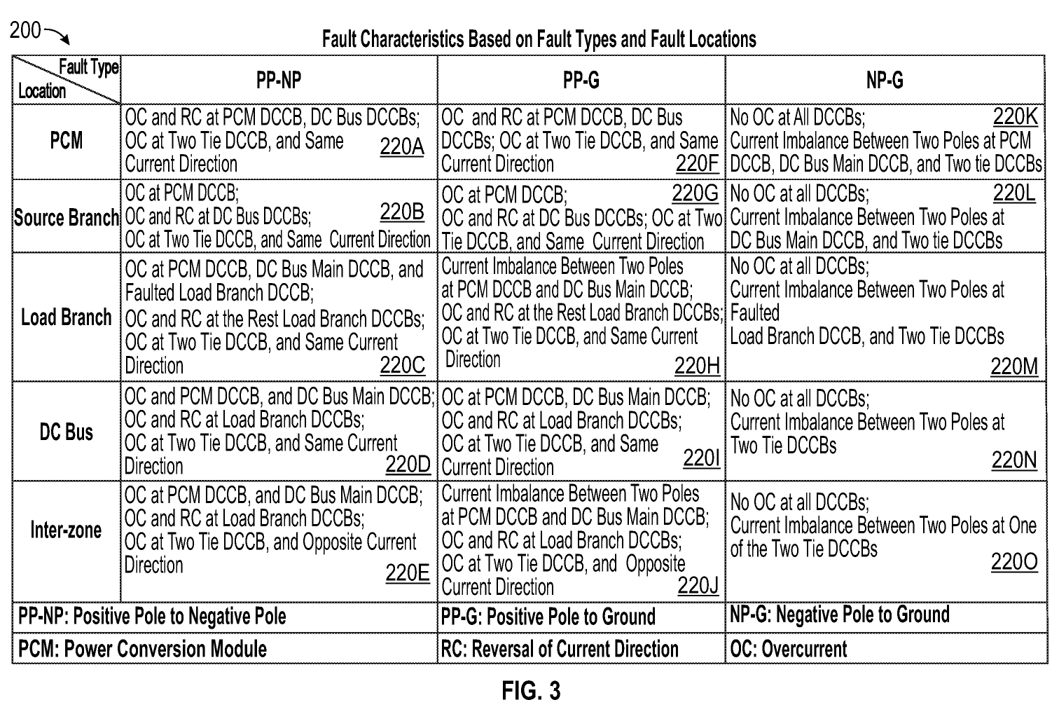

The centralized protection scheme 10 further includes a centralized controller 20 that is in electrical communication with all of the circuit breakers 12. The centralized controller 20 includes a fault characteristic database 200 and a fault matching algorithm module 210. An exemplary embodiment of the database 200 is shown in FIG. 3. As detailed further later herein, the fault characteristic database 200 stores predefined fault characteristics that correspond to each specific fault that can occur in the centralized protection scheme 10, and the fault matching algorithm module 210 compares information collected by all of the circuit breakers 12 to the fault characteristic database 200 in order to identify the type and location of any faults that have occurred. The centralized protection scheme 10 integrates three main functions: (1) signal processing, (2) fault characteristic matching, and (3) fault isolation. The signal processing function is performed by the individual circuit breakers 12, while the fault characteristic matching function is performed by the centralized controller 20 and the fault isolation function is initiated by the centralized controller 20.

### Signal processing

The signal processing function of the centralized protection scheme 10 is implemented by the individual circuit breakers 12, with each circuit breaker 12 monitoring both positive and negative pole currents. In the centralized protection scheme 10, each circuit breaker 12 continuously collects real-time measurements of current from both the positive and negative poles. Each circuit breaker 12 locally processes its collected measurements to detect the presence of two broad categories of abnormal current conditions: (1) overcurrent and reversal of current, or (2) imbalance of current between negative and positive poles. For overcurrent detection, the current measurements from each pole are compared against predefined threshold values. If either pole exceeds the threshold, the circuit breaker 12 flags an overcurrent condition. Additionally, each circuit breaker 12 monitors reversal of current direction to detect anomalies in power flow. For current imbalance detection, each circuit breaker 12 analyzes the sum of the positive and negative pole currents, and compares the sum against predefined threshold values to determine whether there is any current imbalance between the two poles, which can indicate potential faults or irregularities in the system.

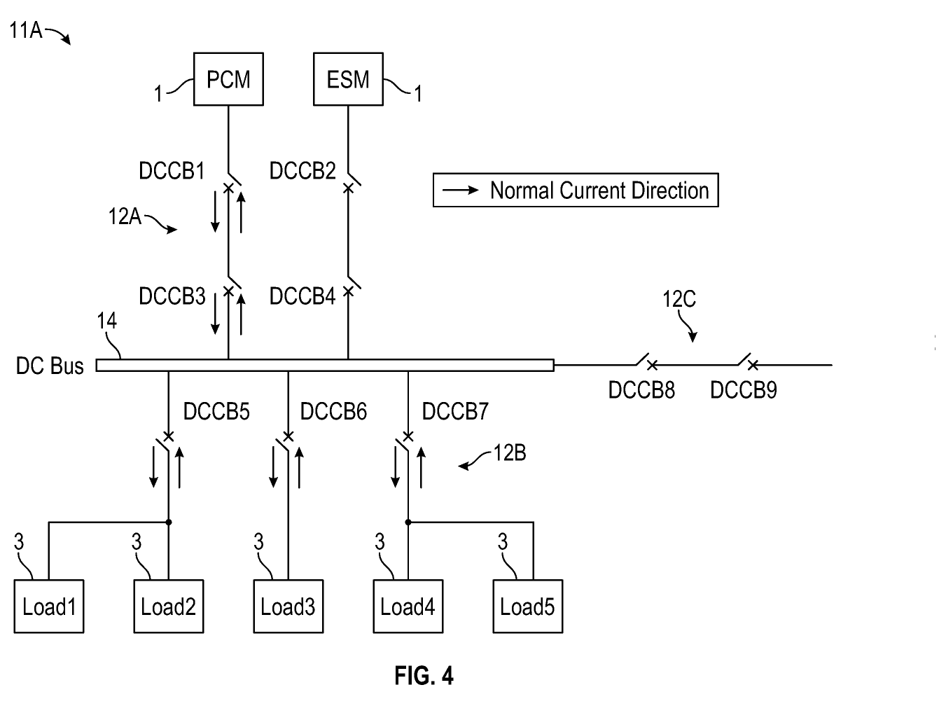

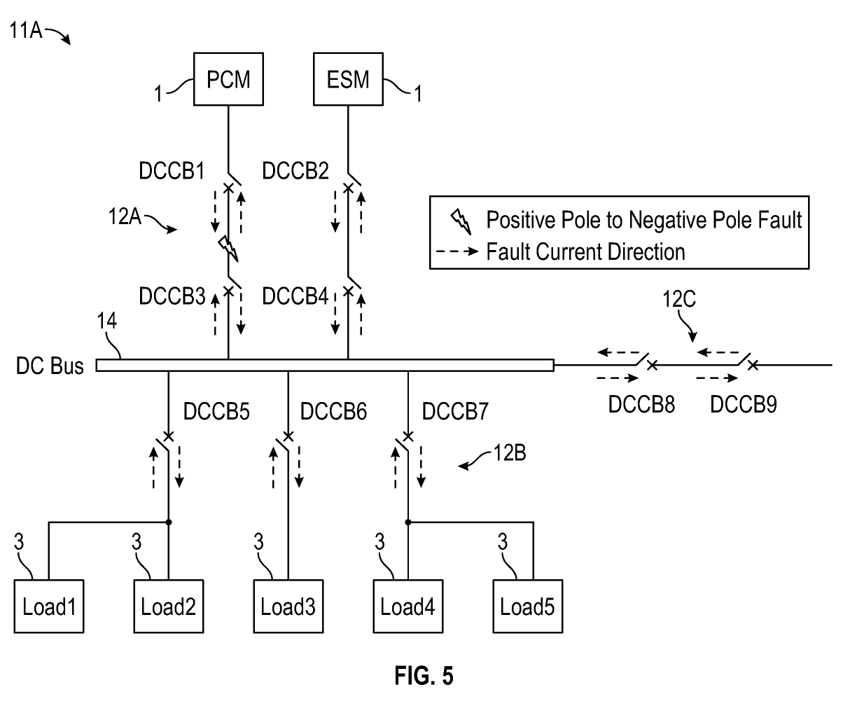

The term “reversal” is used hereinafter to denote a change in direction of current flow that indicates a fault condition. FIG. 4 and FIG. 5 provide a non-limiting illustrative example depiction of how reversal of current manifests during an overcurrent condition. FIG. 4 shows current flow in the interconnected distributed energy system 11A under normal current conditions when the PCM 1 is supplying power to the loads 3. FIG. 5 shows current flow when a Positive Pole to Negative Pole (PP-NP) fault has occurred in the interconnected distributed energy system 11A. The PP-NP fault depicted in FIG. 5 is specifically a source branch PP-NP fault, as the fault occurs between the two source branch breakers 12A labeled DCCB1 and DCCB3.

When the overcurrent fault occurs as shown in FIG. 5, current flow in all circuit breakers 12 downstream of the fault reverses direction relative to the normal direction. In particular, current flow in the circuit breakers 12 labeled DCCB 3 and DCCB 5-7 are all downstream of the overcurrent fault in FIG. 5, and it can be seen that current flow in these specific circuit breakers 12 has reversed direction in FIG. 5 as compared to FIG. 4. The centralized controller 20 is configured to recognize what direction of current flow is considered the normal direction in every circuit breaker 12 in the centralized protection scheme 10 when any combination of the power sources 1 is supplying power to any combination of the loads 3. As such, the centralized controller 20 is also configured to recognize when direction of current flow in any circuit breaker 12 has reversed from the normal direction. It should thus be understood that when the term “reversal” is used herein to describe current flow, this denotes that the centralized controller 20 recognizes for a given circuit breaker 12 that the direction of current flow in that given circuit breaker 12 is reversed from what would be the normal current direction, considering what specific combination of power source(s) 1 and load(s) 3 are connected to a given DC Bus 14 at that specific time.

In a first embodiment of the signal processing function, each circuit breaker 12 provides both the real-time current measurements and the fault conditions (e.g. overcurrent, reversal of current direction, imbalance between poles) flagged locally by the circuit breaker 12 to the centralized controller 20. As used hereinafter, the term “flags” refers to any of the flags transmitted by one of the circuit breakers 12 to the centralized controller 20 to indicate an overcurrent, a reversal of current direction, or an imbalance between poles. For those circuit breakers 12 that have transmitted flags to the centralized controller 20, the centralized controller 20 can additionally evaluate the real-time current measurements associated with the flag(s) to perform fault characteristic matching (detailed further later herein).

Alternatively, in a second embodiment of the signal processing function, the circuit breakers 12 can monitor the overcurrent, direction, and imbalance conditions locally, and only provide corresponding abnormality indications to the centralized controller 20 whenever a specific threshold is exceeded, without additionally providing the real-time current measurements to the centralized controller 20. The centralized controller 20 will then perform fault characteristic matching (detailed further later herein) based only on the fault indication signals received from the individual circuit breakers 12. This second embodiment can be used to reduce communications bandwidth requirements. In both the first and second embodiments, each circuit breaker 12 performs an initial flagging of abnormal current without taking action based on the initial flagging, and instead simply transmits the information to the centralized controller 20 without taking action to interrupt the current.

### Fault characteristic matching and fault isolation

The centralized controller 20 has a set of predefined fault characteristics (i.e. the fault characteristic database 200) stored in its memory. These predefined fault characteristics serve as references for different fault types that can occur in the power distribution system. In particular, for each specific fault that can occur in the centralized protection scheme 10, there is a corresponding set of predefined fault characteristics that will be present in the centralized protection scheme 10 when the specific fault occurs. In FIG. 3, these sets of characteristics are numbered with the reference number 220, and a letter appended to the end of the reference number links each specific set of characteristics to a specific fault type and location. For example and without limitation, the characteristics 220C in FIG. 3 correspond to a Positive Pole to Negative Pole (PP-NP) fault occurring in a load branch, the characteristics 220I in FIG. 3 correspond to a Positive Pole-to-Ground (PP-G) fault occurring in the DC bus 14, and the characteristics 220L correspond to a Negative Pole-to-Ground (NP-G) fault occurring in a source branch.

By comparing the signals received after signal processing from all circuit breakers 12 in each zone 15 with each set of predefined fault characteristics 220 contained in the database 200, the centralized controller 20 can accurately identify the location and type of any fault that has occurred. Once the centralized controller 20 determines the fault type and location by referencing the database 200, the centralized controller 20 sends control signals to only those circuit breakers 12 (as detailed further later herein) that are necessary for isolating the affected zone(s) 15 (or section of a zone 15), thus preserving functionality in unaffected zones 15.

### Method of isolating faults

FIG. 2 is a method 100 of isolating faults within a power distribution system, in accordance with an example embodiment of the disclosed concept. The method 100 is executed, for example, by the centralized controller 20 of the centralized protection scheme 10 depicted in FIG. 1 and is described in conjunction with the centralized protection scheme 10. However, it will be appreciated that the method 100 may be employed in other systems as well without departing from the scope of the disclosed concept. The fault characteristic database 200 shown in FIG. 3 is utilized during the method 100 and reference will also be made to the database 200 of FIG. 3 while detailing the steps of the method 100.

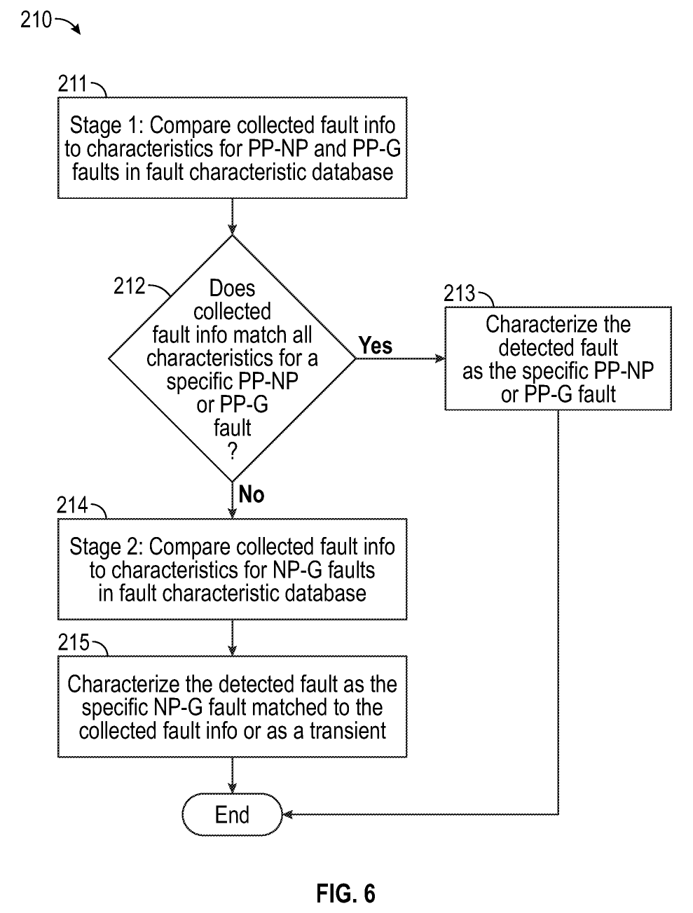

At step 101, the centralized controller 20 continuously monitors signals received from all of the circuit breakers 12 in the centralized protection scheme 10. At step 102, the centralized controller 20 determines whether any flags for current irregularities were transmitted to the centralized controller 20 by any of the circuit breakers 12 at step 101. Said current irregularities include overcurrent, reversal of current direction, and current imbalance between two poles. Said current irregularities can also be indicative of transients, as detailed further later herein. If the centralized controller 20 did not receive any of the aforementioned flags, then the method returns to step 101. If the centralized controller 20 did receive one of the aforementioned flags, then the method proceeds to step 103, wherein the centralized controller 20 commences running an algorithm for fault type identification. It is noted that the fault matching algorithm module 210 of the controller 20 runs the algorithm for fault type identification, and for the sake of simplicity, the reference number 210 will be used to refer to both the fault matching module and the algorithm that the fault matching module runs. The algorithm 210 is discussed briefly hereafter in conjunction with steps 104 and 106 of the method 100, and is also detailed further later herein in conjunction with FIG. 6.

The method then proceeds to step 104, where the centralized controller 20 performs a first stage of the fault type identification algorithm 210. At this first stage, for every circuit breaker 12 from which the centralized controller 20 received a flag, the centralized controller 20 compares the flags and any other current data received from the circuit breakers 12 to those sets of characteristics 220 corresponding to PP-G faults and PP-NP faults in the database 200 to determine whether the detected fault condition is either of a PP-G or PP-NP fault. If the centralized controller 20 determines that the data received from the circuit breakers 12 matches all of the characteristics included in a single set of characteristics 220 in the database 200 (i.e. a single set of characteristics 220 corresponding to a single cell in the table of FIG. 3), then the controller 200 determines the type (i.e. PP-G or PP-NP) and location of the fault in accordance with the type and location that correspond to the single set of characteristics 220. The method then proceeds to step 105, where the centralized controller 20 further determines which of the circuit breakers 12 should be tripped in order to isolate the identified PP-G or PP-NP fault, as detailed further later herein. The centralized controller 20 then accordingly transmits a trip signal to the one or more circuit breakers 12 identified as needing to be tripped open in order to isolate the PP-G or PP-NP fault.

If the controller 20 instead determines at step 104 that the fault condition is not a PP-G or PP-NP fault, then the method proceeds to step 106, where the centralized controller 20 performs a second stage of the fault type identification algorithm 210. At this second stage, for every circuit breaker 12 from which the centralized controller 20 received a flag, the centralized controller 20 compares the flags and any other current data received from the circuit breakers 12 to those characteristics 220 corresponding to NP-G faults in the database 200. The controller 20 compares the data received from the circuit breakers 12 to each set of characteristics 220 in the database 200 for NP-G faults, and if the received data matches a single set of characteristics 220 for NP-G faults, the controller 20 then determines the location of the NP-G fault in accordance with the location that corresponds to the single set of characteristics 220.

The method then proceeds to step 108, where the centralized controller 20 notifies the system operator of the NP-G fault without generating any tripping signals. For NP-G faults, no tripping signals are generated at step 108 since no overcurrent is observed. In contrast, the overcurrent generated by a PP-G or PP-NP fault can lead to excessive generation of heat, thereby increasing the risk of fire or damage to equipment and thus necessitating tripping of the relevant circuit breakers 12 at step 105. If the controller 20 determines at step 106 that the data received from the circuit breakers 12 does not indicate a fault, the controller 20 will instead determine that the irregularity is a transient, after which the centralized controller 20 returns to step 101 to continue monitoring all circuit breakers 12 in the system. It is noted that transients are expected to last only a short time and resolve themselves without causing any lasting significant effects on the power distribution system. Thus, no further action is taken by the controller 20 to address the transient after step 106 before returning to step 101.

If a trip signal was sent to any circuit breakers 12 at step 105 due to identification of a PP-G or PP-NP fault, then the method proceeds to step 107, where the centralized controller 20 performs a fault clearance check. If the centralized controller 20 determines at step 107 that the identified fault has been successfully cleared within a predetermined acceptable window of time, then the method returns to step 101 to continue monitoring all circuit breakers 12 in the system. If, however, the centralized controller 20 determines at step 107 that the identified fault has not yet been cleared in the predetermined acceptable window of time, then the method proceeds to step 109 where the centralized controller 20 performs backup protection by tripping backup circuit breakers 12, as detailed further later herein.

### Fault Characteristic Database

Further details of the fault characteristic database 200 shown in FIG. 3 are now provided. As an initial matter, it should be noted that the circuit breakers 12 are referred to using the term “DCCB” in FIG. 3. In the database 200, the PCM branch has its own row separate from the row used for the other source branches, as the nature of a power conversion module is such that it exhibits unique fault behavior compared to other power sources. In the database 200, the row of the database 200 labeled “PCM” refers to a fault that occurs between the PCM 1A and the closest downstream circuit breaker 12, i.e. the circuit breaker 12 labeled DCCB1 in FIG. 1. The row of the database 200 labeled “Source Branch” refers to a fault occurring anywhere in the ESM branch or a fault occurring between the circuit breakers 12 labeled DCCB 1 and DCCB 3 in the PCM branch. In addition: the row of the database 200 labeled “Load Branch” refers to a fault occurring in any branch of the power distribution network connecting one of the loads 3 to the DC bus 14; the row of the database 200 labeled “DC Bus” refers to a fault occurring in the DC bus 14; the row of the database 200 labeled “Inter-zone” refers to a fault occurring between two adjacent zones 15, i.e. between two adjacent tie breakers 12C; and the row of the database 200 labeled “PCM” refers to a fault occurring in any branch of the power distribution network connecting a power conversion module to the DC bus 14.

It will be appreciated that, for a given set of characteristics 220 in the database 200, the characteristics included that given set of characteristics 220 pertain to the state of current observed at multiple specific circuit breakers 12 throughout the power distribution system due to the occurrence of the specific fault associated with that given set of characteristics 220. For each specific fault listed in the table in FIG. 3, that specific fault is determined to be present in the power distribution system only when all of the characteristics listed in the corresponding cell in the table are present in the zone 15 of the fault.

An important feature of the disclosed centralized protection scheme 10 is its ability to distinguish between transient events and true faults. This is achieved by comparing the current signatures recorded by all circuit breakers 12 against the reference database 200 of known fault patterns. Since transients are typically localized and confined to a single branch, their effects do not propagate across the entire network. As a result, abnormal current behavior observed during transients are isolated to specific circuit breakers 12, while the rest of the system remains unaffected. In contrast, true faults lead to system-wide current disturbances, reflected across multiple circuit breakers 12. By leveraging this spatial signature difference, the centralized protection scheme 10 can reliably discriminate between transient phenomena and actual faults, thereby minimizing false tripping and enhancing system reliability.

### Fault Matching Algorithm

The fault matching algorithm 210 discussed in conjunction with steps 104 and 106 will be discussed now in conjunction with FIG. 6. Steps 211-213 of the fault matching algorithm correspond to step 104 of the fault isolation method 100. At step 211, the controller 20 compares the aggregated current data received from all of the circuit breakers 12 to each set of characteristics 220 for PP-NP and PP-G faults in the database 200, i.e. the sets numbered 220A-220J in FIG. 3. If the controller 220 determines that the aggregated current data includes all of the characteristics for one of the sets of characteristics 220 for a PP-NP or PP-G fault, then the controller characterizes the fault by its type (PP-G or PP-NP) and location in accordance with the database 200.

Steps 214-215 of the fault matching algorithm correspond to step 106 of the fault isolation method 100. At step 214, the controller 20 compares the aggregated current data received from all of the circuit breakers 12 to each set of characteristics 220 for NP-G faults in the database 200, i.e. the sets numbered 220K-220O in FIG. 3. If the controller 220 determines that the aggregated current data includes all of the characteristics for one of the sets of characteristics 220 for a NP-G fault, then the controller characterizes the fault by its type (NP-G) and location in accordance with the database 200. If however, the controller 220 determines that the aggregated current data does not include all of the characteristics for any of the sets of characteristics 220 for a NP-G fault, then the controller 220 instead determines that the aggregated current data corresponds to a transient event.

In the interest of thoroughness and increasing clarity of the disclosed centralized protection scheme 10, additional discussion of the various sets of characteristics 220 included in the database 200 for each type of fault that can occur in the centralized protection scheme 10 will now be provided, including which circuit breakers 12 should be tripped to isolate the fault (such as at step 105 of the fault isolation method 100) while minimizing disruption to the non-faulted zones 15.

### PP-NP faults

The centralized controller 20 determines that a PP-NP fault has occurred in a zone 15 when the overcurrent condition is detected by at least one circuit breaker 12 in the zone 15, and if there is reversal of current direction detected by all of the other circuit breakers 12 in the zone 15.

### Source branch PP-NP faults

For a given source branch, a source branch PP-NP fault has occurred when, starting from the closest circuit breaker 12 that is downstream of the fault, all circuit breakers 12 inside the zone 15 of the fault (including source branch circuit breakers 12A and all load branches’ circuit breakers 12B), which are necessarily downstream of said closest circuit breaker 12, exhibit the overcurrent condition and a reversal of current direction. In addition, if there is any source branch circuit breaker 12A upstream of said closest circuit breaker 12, then said upstream source branch circuit breaker 12A will exhibit the overcurrent condition, with the current being in the normal direction. Lastly, any tie circuit breakers 12C will exhibit the overcurrent condition, and the current flow in the two adjacent tie circuit breakers 12C will be in the same direction.

When a PP-NP source branch fault is determined to have occurred, the centralized controller 20 decides which circuit breaker(s) 12 to trip by first identifying the source branch circuit breaker 12A most downstream of the fault that exhibits both the over current condition and the reversal of current direction. Once the most downstream source branch circuit breaker 12A is identified, the centralized controller 20 instructs both the most downstream source branch circuit breaker 12A and the closest source branch circuit breaker 12A upstream of the fault to trip in order to isolate the PP-NP fault. Tripping the most downstream source branch circuit breaker 12A will isolate the PP-NP fault from the rest of the system, while tripping the closest upstream circuit breaker 12A will isolate the source from the PP-NP fault.

### Load branch PP-NP faults

For a given load branch, a load branch PP-NP fault has occurred in the load branch when: the load branch circuit breakers 12B for all other load branches in the zone 15 exhibit the overcurrent condition and reversal of current direction; all source branch circuit breakers 12A in the zone 15 and the load branch circuit breaker 12B at the faulted load branch exhibit the overcurrent condition with current flow being in the normal direction; and any tie circuit breakers 12C will exhibit the overcurrent condition, and the current flow in the two adjacent tie circuit breakers 12C will be in the same direction.

When a load branch PP-NP fault occurs, the load branch circuit breaker 12B where the load branch fault appears will exhibit an overcurrent in the normal direction, and the centralized controller 20 instructs the load branch circuit breaker 12B where the load branch fault appears to trip open to interrupt the fault, in order to isolate the fault from the rest of the system to achieve selectivity.

### DC Bus PP-NP faults

A DC Bus PP-NP fault is determined to have occurred when, inside the zone 15 of the DC Bus fault: all source branch circuit breakers 12A exhibit the overcurrent condition with current in the normal direction; all load branch circuit breakers 12B exhibit the overcurrent conditionand reversal of current direction; and the tie circuit breakers 12C exhibit the overcurrent condition with the current flow in the two adjacent tie circuit breakers 12C being in the same direction.

When a DC Bus PP-NP fault occurs, the centralized controller 20 instructs all source branch breakers 12A and the tie circuit breaker 12C of the zone 15 of the DC Bus fault to trip in order to interrupt the DC Bus fault, so that even if the zone 15 of the DC Bus fault will be out of service, loads in other zones 15 will not be affected.

### Inter-zone PP-NP faults

An interzone PP-NP fault (i.e. a fault occurring between two tie breakers 12C) is determined to have occurred when: all source branch breakers 12A exhibit the overcurrent condition with same current direction (i.e. all source branch breakers 12A in the two interconnected distributed energy systems 11 adjacent to the tie breakers 12C), wherein all load branch breakers 12B exhibit the overcurrent condition with reversal of current direction (i.e. all load branch breakers 12B in the two interconnected distributed energy systems 11 adjacent to the tie breakers 12C), and wherein the tie breakers 12C exhibit the overcurrent condition and the current flow in two adjacent tie breakers 12C is in opposite directions.

When an inter-zone PP-NP fault occurs, the current flow direction in two adjacent tie breakers 12C can be used to distinguish between an inter-zone fault and an intra-zone fault, an intra-zone fault being a fault that occurs inside of a zone 15. For an inter-zone fault, the current flow in two adjacent tie breakers 12C will be in opposite directions, whereas for an intra-zone fault, the current flow direction in two adjacent tie breakers 12C will be the same.

When an interzone PP-NP fault occurs, the centralized controller 20 instructs both tie circuit breakers 12C adjacent to the interzone fault to trip open in order to isolate the interzone fault from the other zones 15, so that all of the loads 3 of all other zones 15 will not be affected.

### Positive Pole-to-Ground (PP-G) faults

In order to determine PP-G fault locations in a zone 15, the controller 20 reviews the data received from all circuit breakers 12 in the zone 15 to determine for all of the circuit breakers 12 whether the overcurrent condition, a reversal of current direction, and a current imbalance between the two poles exists. The difference between detecting a PP-NP fault and a PP-G fault is that for a PP-G fault, the overcurrent condition in the positive pole, the reversal of current direction in the positive pole, and the current imbalance between the two poles are used to detect the PP-G fault. In contrast, for a PP-NP fault, the overcurrent condition for both poles and the reversal of current direction for both poles are used to identify the PP-NP fault. The method of determining the fault location (i.e. source branch, load branch, inter-zone, DC Bus) for a PP-G fault is the same as already described above for the various PP-NP faults.

### Negative Pole-to-Ground (NP-G) faults

In order to determine that a NP-G fault exists in a zone 15, the controller 20 reviews the data received from all circuit breakers 12 in the zone 15 to determine which circuit breakers 12 have reported a current imbalance between the two poles, and the controller 20 confirms that no circuit breakers 12 in the zone exhibit the overcurrent condition.

### Source branch NP-G faults

To determine that a NP-G fault occurred in a source branch, the centralized controller 20 locates the most upstream circuit breaker 12 closest to the fault that exhibits the condition of current imbalance between two poles and identifies this circuit breaker 12 as the source branch circuit breaker 12A that is most downstream to the fault. In a source branch NP-G fault, the tie circuit breakers 12C will also exhibit the condition of current imbalance between the two poles. The centralized controller 20 will send a fault indication signal to the system operator to alert the system operator of the NP-G fault appearance at the source branch.

### Load branch NP-G faults

To determine that a NP-G fault occurred in a load branch, the centralized controller 20 identifies the load branch circuit breaker 12B that exhibits the condition of current imbalance between two poles. In a load branch NP-G fault, the tie breakers 12C will also exhibit the condition of current imbalance between the two poles. The centralized controller 20 will send a fault indication signal to the system operator to alert the system operator of the NP-G fault appearance at the load branch.

### DC Bus NP-G faults

The centralized controller 20 determines that a NP-G fault occurred at the DC Bus 14 when only the two tie circuit breakers 12C (and no source or load circuit breakers 12A, 12B) exhibit the condition of current imbalance between two poles. The centralized controller 20 will send a fault indication signal to the system operator to alert the system operator of the NP-G fault appearance at the DC Bus.

### Inter-zone NP-G faults

The centralized controller 20 determines that a NP-G fault occurred between zones 15 (i.e. inter-zone) when only one of the two tie circuit breakers 12C (and no source or load circuit breakers 12A, 12B) exhibits the condition of current imbalance between two poles. The centralized controller 20 will send a fault indication signal to the system operator to alert the system operator of the NP-G fault appearance between zones 15.

### Restoration and Reconfiguration

Following successful fault isolation, the disclosed centralized protection scheme 10 enables system restoration and reconfiguration under several conditions. Restoration of power to disconnected loads 3 is possible when the network includes alternative power paths and intelligent switching capabilities. In such cases, for any load 3 that has been disconnected from a specific power source 1 due to detection of a fault attributable to that specific power source 1, the centralized controller 20 is configured to reroute other remaining power sources 1 to supply power to the load 3 to maintain service continuity. In particular, the centralized controller 20 determines if the remaining power sources 1, such as generators or distributed energy resources (DERs), have sufficient capacity. If said remaining power sources 1 do have sufficient capacity, the controller 20 will progressively restore non-faulted areas, giving priority to critical loads 3. When the remaining power sources 1 do not have capacity to fully power all remaining loads 3 immediately after fault isolation, the centralized controller 20 can actuate partial load shedding in order to facilitate balanced load restoration. The following is a non-limiting illustrative example demonstrating how restoration and reconfiguration are carried out after successful fault isolation when a fault occurs on a DC bus 14 within one specific interconnected distributed energy system 11 (e.g. the system 11A in FIG. 1). After the fault is isolated by opening the source and tie breakers 12A and 12C in said one specific interconnected distributed energy system 11, the centralized controller 20 automatically reconfigures the connections between any affected loads 3 and remaining power sources 1 by closing interconnected normally open breakers 12 (e.g. tie breakers 12C) to restore power to unaffected downstream loads 3 by supplying said downstream loads 3 from an alternate DC bus 14 (e.g. the DC bus 14 of the system 11B in FIG. 1). This minimizes the outage area and restores service quickly without manual intervention.

Restoration and reconfiguration are not possible when a fault occurs on a critical path without redundancy, or when power sources 1 are insufficient to meet demand. The following is a non-limiting illustrative example demonstrating when restoration and reconfiguration are not possible when a fault occurs on a load branch. After the fault is isolated by opening the branch breaker 12B, there is no alternate path to feed this load 3. This load 3 must remain unpowered until the fault has been addressed, and only afterward can this load 3 be reconnected to a power source 1. However, only the faulted load 3 is affected, and the remaining system can operate without interruption while the faulted load branch is selectively cleared.

### Tripping of backup circuit breakers

As should be understood from the foregoing detailed description, in the event of a fault, the centralized controller 20 is configured to initiate the tripping of only those circuit breakers 12 nearest to the fault and necessary to isolate the fault from the rest of the power distribution system. However, and as previously noted in connection with step 109 of the fault isolation method 100, if the centralized controller 20 determines that an identified fault has not been cleared within a predetermined acceptable window of time after tripping only the nearest circuit breakers, the centralized controller 20 performs backup protection by tripping backup circuit breakers 12 further removed from the fault.

It will be appreciated that the determination of which circuit breakers 12 should be tripped as backup for each specific fault may vary somewhat depending on the context of use for a specific power distribution system, but two non-limiting examples of which circuit breakers 12 should be tripped as backup now follow. In a first non-limiting example, when there is a load branch fault, if the nearest load branch breaker 12B fails to trip, then the centralized controller 20 will instruct both the source branch breaker 12A (upstream of the fault in the same zone 15) and the tie breaker 12C (upstream of the zone 15 of the fault and upstream of other zones 15) to trip as backup breakers 12. In a second non-limiting example, when there is an inter-zone fault, if either tie breaker 12C fails to trip, then the centralized controller 20 will instruct both the nearest source branch breakers 12A in the zones 15 immediately adjacent to the tie breakers 12C to trip as backup breakers 12.

### Advantages of the disclosed centralized protection scheme

Traditional DC power protection schemes focus on decentralized protection with individual DC circuit breakers operating independently. In contrast, the centralized protection scheme 10 and method 100 disclosed herein offer a new solution that combines centralized, real-time fault characteristic matching with zonal isolation. As a result, and as should be understood from the foregoing detailed description of the centralized protection scheme 10, even though several circuit breakers in a zonal power distribution may detect an overcurrent condition when there is a fault in one zone, it is possible in the centralized protection scheme 10 to isolate the fault from the rest of the system by only tripping those circuit breakers 12 nearest the fault, whereas in known protection schemes, all circuit breakers that detect the overcurrent condition are typically tripped, resulting in network-wide outages. That is, among other advantages, the disclosed centralized protection scheme 10 and method 100 provide a fault management approach that is faster and more sophisticated than known approaches, as the centralized controller 20 ensures coordinated and accurate isolation.

By analyzing the DCCB data centrally with the centralized controller 20, faults are identified more quickly, reducing response time, minimizing downtime and potential damage, and preserving power availability (i.e. preventing unnecessary interruptions) in unaffected areas. In addition, the disclosed centralized protection scheme 10 and method 100 enable precise identification of fault location and type, thus significantly reducing troubleshooting time, while ensuring that transient events do not impact fault detection accuracy. The disclosed centralized protection scheme 10 and method 100 do this using only low data payload communications with the centralized controller via low bandwidth, noise resilient digital logic signaling (i.e. two bits: current direction and if overcurrent threshold exceeded). In sum, the disclosed centralized protection scheme 10 enhances reliability, reduces downtime, and minimizes the risk of damage to critical components.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A centralized controller for managing faults in a DC power distribution system, there being a positive pole and a negative pole of the DC power distribution system, the DC power distribution system comprising a plurality of interconnected distributed energy systems and a plurality of direct current circuit breakers, DCCBs; the plurality of DCCBs including a plurality of source branch breakers, a plurality of load branch breakers, and a plurality of tie breakers; each of the interconnected distributed energy systems being configured to be connected to and disconnected from at least one other of the interconnected distributed energy systems via a number of the tie breakers; each interconnected distributed energy system including a plurality of power sources, a plurality of loads, and a DC Bus, with each power source being connected to a number of the source branch breakers in a source branch such that any of the number of the source branch breakers can be tripped in order to interrupt current flowing from the power source to the DC Bus, and with each load being connected to a number of the load branch breakers in a load branch such that any of the number of the load branch breakers can be tripped in order to interrupt current flowing through the DC Bus to the load; each interconnected distributed energy system being configured to include a number of zones such that, within each zone, each power source is configured to supply power to a subset of the plurality of loads that is unique relative to any other power source in the DC power distribution system; the centralized controller comprising:
a fault characteristic database, the fault characteristic database including a plurality of sets of characteristics, with each set of characteristics corresponding to a unique combination of a fault type and a location in the DC power distribution system, such that the combination corresponding to any given set of characteristics is unique relative to all other combinations corresponding to all other sets of characteristics in the fault characteristic database,
wherein the centralized controller is configured to execute a method for isolating faults in the DC power distribution system, the method comprising:
continuously monitoring electrical current data transmitted by all DCCBs in the DC power distribution system with the centralized controller;
when the electrical current data includes any flag for a present current irregularity, running an algorithm for fault matching with the centralized controller to compare the electrical current data to the fault characteristic database;
performing fault type identification with the centralized controller during the running of the algorithm, wherein performing fault type identification includes:
first determining if the electrical current data matches one specific set of characteristics out of the plurality of sets of characteristics in the fault characteristic database,
when the electrical current data is determined to match the one specific set of characteristics, next determining that the present current irregularity is a fault of the fault type and location that the one specific set of characteristics corresponds to, including determining whether the present current irregularity is of a PP-G fault type, a PP-NP fault type, or a NP-G fault type;
when the electrical current data corresponds to the PP-G fault type or to the PP-NP fault type, isolating the fault by:
transmitting a trip signal with the centralized controller to only the DCCB or DCCBs immediately adjacent to the fault;
determining with the centralized controller whether the present fault has been cleared within a predetermined acceptable window of time;
when the present fault has been cleared within the predetermined acceptable window of time, proceeding to continuously monitor electrical current data transmitted by all DCCBs in the DC power distribution system with the centralized controller; and
when the present fault has not yet been cleared within the predetermined acceptable window of time, proceeding to trip a number of the DCCBs that are backup DCCBs, the backup DCCBs being those DCCBs that are next-closest and upstream relative to the present fault; and
when the electrical current data corresponds to the NP-G fault type:
notifying a system operator of the present fault and proceeding to continuously monitor electrical current data transmitted by all DCCBs in the DC power distribution system with the centralized controller.

2. The centralized controller of claim 1,
wherein the electrical current data indicates at least one of the following: an overcurrent condition, reversal of current direction, or current imbalance between the positive and negative poles in any zone.

3. The centralized controller of claim 2,
wherein the centralized controller is configured to determine that the present fault is located in a specific zone of the plurality of zones and that the present fault is of the PP-NP fault type when:
the electrical current data indicates that an overcurrent condition is detected by at least one DCCB of the plurality of DCCBs in the specific zone, and
the electrical current data indicates that all DCCBs in the specific zone other than the at least one DCCB have detected a reversal of current direction.

4. The centralized controller of claim 3,
wherein the centralized controller is configured to determine that the present fault is a source branch fault of the PP-NP fault type when:
the electrical current data indicates that all DCCBs inside the zone of the present fault and downstream of the present fault, including source branch breakers and load branch breakers, have detected the overcurrent condition and the reversal of current direction,
provided that there is any source branch breaker upstream of the present fault, the electrical current data indicates that said upstream source branch breaker has detected the overcurrent condition with the current flowing in a normal direction, and
for the given interconnected distributed energy system in which the present fault is located and for those tie breakers that connect the given interconnected distributed energy system to another of the interconnected distributed energy systems, those tie breakers being adjacent to one another, the electrical current data indicates that those tie breakers have detected the overcurrent condition and have detected that current flowing in those tie breakers is in the same direction.

5. The centralized controller of claim 4,
wherein the centralized controller is configured to identify from the electrical current data which of the source branch breakers is a most downstream source branch breaker relative to the present fault that has detected the overcurrent condition and the reversal of current direction,
wherein the centralized controller is configured to identify from the electrical current data which of the source branch breakers is a closest upstream source branch breaker relative the present fault,
wherein the centralized controller is configured to instruct both the most downstream source branch breaker and the closest upstream source branch breaker to trip in order to isolate the present fault.

6. The centralized controller of claim 3,
wherein the centralized controller is configured to determine that the present
fault is a load branch fault of the PP-NP fault type when:
the electrical current data indicates that all source branch breakers
in the zone of the present fault and a load branch breaker adjacent to the present fault have detected the overcurrent condition, with the current flowing in a normal direction,
the electrical current data indicates that all load branch breakers in the
zone of the present fault, aside from the load branch breaker adjacent to the present fault, have detected both the overcurrent condition and reversal of current direction, and
for the given interconnected distributed energy system in which the
present fault is located and for those tie breakers that connect the given interconnected distributed energy system to another of the interconnected distributed energy systems, those tie breakers being adjacent to one another, the electrical current data indicates that those tie breakers have detected the overcurrent condition and have detected that current flowing in those tie breakers is in the same direction.

7. The centralized controller of claim 6,
wherein the centralized controller is configured to instruct the load branch breaker
adjacent to the present fault to trip in order to isolate the present fault.

8. The centralized controller of claim 3,
wherein the centralized controller is configured to determine that the present fault
is a DC Bus fault of the PP-NP fault type when the electrical current data indicates that, inside the zone of the DC Bus fault:
all source branch breakers have detected the overcurrent condition with the current flowing in a normal direction,
all load branch breakers have detected the overcurrent condition with some of the load branch breakers having detected the current flowing in the normal direction and some of the load branch breakers having detected the reversal of current direction, and
for the given interconnected distributed energy system in which the present fault is located and for those tie breakers that connect the given interconnected distributed energy system to another of the interconnected distributed energy systems, those tie breakers being adjacent to one another, the electrical current data indicates that those tie breakers have detected the overcurrent condition with the current flow direction in those tie breakers being in the same direction.

9. The centralized controller of claim 8,
wherein, the centralized controller is configured such that, when the centralized controller determines that the present fault is a DC Bus fault, the centralized controller instructs both a DC Bus main DCCB and one of the tie breakers in the zone of the DC Bus fault to trip open in order to isolate the fault, such that loads in zones outside of the zone of the DC Bus fault can remain operational,
wherein the DC Bus main DCCB is one source branch breaker of the plurality of source branch breakers that is located nearest to the present fault.

10. The centralized controller of claim 3,
wherein the centralized controller is configured to determine that the present fault is an inter-zone fault of the PP-NP fault type occurring between two tie breakers, the two tie breakers connecting a first interconnected distributed energy system of the interconnected distributed energy systems to a second interconnected distributed energy system of the interconnected distributed energy systems, when the electrical current data indicates:
that all source branch breakers in the first interconnected distributed energy system and in the second interconnected distributed energy system have detected the overcurrent condition, with current detected by all of the source branch breakers in the first interconnected distributed energy system and second interconnected distributed energy system being in a normal direction,
that all load branch breakers in the first interconnected distributed energy system and the second interconnected distributed energy system have detected the overcurrent condition and reversal of current direction, and
two adjacent tie breakers between the first zone and the second zone have detected the overcurrent condition and the current flow in the two adjacent tie breakers is in opposite directions.

11. The centralized controller of claim 10,
wherein the centralized controller is configured to determine that the present fault is an inter-zone fault when, for the given interconnected distributed energy system in which the present fault is located and for those tie breakers that connect the given interconnected distributed energy system to another of the interconnected distributed energy systems, those tie breakers being adjacent to one another, the electrical current data indicates that those tie breakers have detected that current flow in each of those tie breakers is in opposite directions relative to the other of those tie breakers, and
wherein the centralized controller is configured to determine that the present fault is an intra-zone fault when the electrical current data indicates that those tie breakers have detected that current flow direction in each of those tie breakers is the same relative to the other of those tie breakers.

12. The method of claim 10,
wherein, the centralized controller is configured to instruct both of the tie DCCBs to trip in order to isolate the present fault from other zones when the present fault is the interzone fault of the PP-NP type, so that loads outside of the zones of the fault can remain operational, when the present fault is the interzone fault of the PP-NP type.

13. The centralized controller of claim 2,
wherein the centralized controller is configured to determine that the present fault is of the PP-NP fault type when the electrical current data indicates that all of the DCCBs in the zone of the fault have detected: the overcurrent condition in both the positive and negative poles, reversal of current direction in both the positive and negative poles, and current imbalance between the positive and negative poles,
wherein the the centralized controller is configured to determine if the present fault is of the PP-G fault type when the electrical current data indicates that all of the DCCBs in the zone of the fault have detected: the overcurrent condition in the positive pole, reversal of current direction in the positive pole, and current imbalance between the positive and negative poles.

14. The centralized controller of claim 2,
wherein the centralized controller is configured to determine that the present fault is of the NP-G fault type when the electrical current data indicates that:
all of the DCCBs in the zone of the fault have detected current imbalance between the positive pole and the negative pole, and
no DCCBs in the zone of the fault have detected the overcurrent condition.

15. The centralized controller of claim 14,
wherein the centralized controller is configured to determine that the present fault is located at a given source branch in a first interconnected distributed energy system, the present fault being of the NP-G fault type, when a first DCCB that exhibits the condition of current imbalance between the positive and negative pole is identified as the source branch breaker most downstream of the fault,
wherein for two tie breakers connecting the first interconnected distributed energy system to a second interconnected distributed energy system, the two tie breakers both also exhibit the condition of current imbalance between the positive and negative pole, and
wherein the centralized controller is configured to send a fault indication signal to the system operator to alert the system operator of the present fault, its NP-G fault type, and its appearance at the given source branch.

16. The centralized controller of claim 14,
wherein the centralized controller is configured to determine that the present fault is located at a load branch in a first interconnected distributed energy system, the present fault being of the NP-G fault type, when the electrical current data indicates that:
the condition of current imbalance between the positive pole and negative
pole appears at a faulted load branch breaker in the first interconnected distributed energy system, and
for two tie breakers connecting the first interconnected distributed energy system to a
second interconnected distributed energy system, the two tie breakers also exhibit the condition of current imbalance between the positive pole and negative pole, and
wherein the controller is configured to send a fault indication signal to the system operator to alert the system operator of the present fault, its NP-G fault type, and its appearance at the faulted load branch.

17. The centralized controller of claim 14,
wherein the centralized controller is configured to determine that the present fault is located at the DC Bus of a zone in a first interconnected distributed energy system, the present fault being of the NP-G fault load type, when the electrical current data indicates that for two tie breakers connecting the first interconnected distributed energy system to a second interconnected distributed energy system, the two tie breakers both exhibit the condition of current imbalance between the positive and negative pole, and
wherein the controller is configured to send a fault indication signal to the system operator to alert the system operator of the present fault, its NP-G fault type, and its appearance at the DC Bus of the zone.

18. The centralized controller of claim 14,
wherein the centralized controller is configured to determine that the present fault is located between two zones, the present fault being of the NP-G fault type when the electrical current data indicates that only one of the two tie breakers connected between the two zones exhibits the condition of current imbalance between the negative pole and the positive pole, and
wherein the controller is configured to send a fault indication signal to the system operator to alert the system operator of the present fault, its NP-G fault type, and its appearance between the two zones.

19. The centralized controller of claim 1,
wherein, during running of the algorithm, the centralized controller is configured to determine that the current irregularity is a transient condition when the centralized controller determines that the electrical current data does not match any specific set of characteristics out of the plurality of sets of characteristics in the fault characteristic database.

20. The centralized controller of claim 1,
wherein for each load in the DC power distribution system, the controller is configured to: determine whether the load is a critical load or a non-critical load and assign a priority order to the load, with the priority order denoting when the centralized controller will act to reconnect the load to power relative to other loads when the load gets disconnected from power,
wherein the centralized controller is configured such that:
when a given load of the plurality of loads has been disconnected from a given power source of the plurality of power sources due to the fault originating from the given power source and the fault having been isolated, the centralized controller determines whether any of the remaining power sources in the DC power distribution system other than the given power source has sufficient capacity to power the given load, and
when the centralized controller determines that at least one power source in the remaining power sources has sufficient capacity to power the given load:
the centralized controller closes any DCCBs in the plurality of DCCBs necessary to enable the at least one power source to supply power to the given load, while complying with the priority order and ensuring that all critical loads in the DC power distribution system are configured to receive power before any non-critical loads in the DC power distribution system receive power.
